(19) United States
(12) Patent Application Publication
(10) Pub. No.: US 2013/0293677 A1
(43) Pub. Date: Nov. 7, 2013

(54) RECEPTION DEVICE FOR RECEIVING A PLURALITY OF REAL-TIME TRANSFER STREAMS, TRANSMISSION DEVICE FOR TRANSMITTING SAME, AND METHOD FOR PLAYING MULTIMEDIA CONTENT

(71) Applicants: Jae-jun Lee, Suwon-si (KR); Moon-seok Jang, Seoul (KR); Hong-seok Park, Anyang-si (KR); Yu-sung Joo, Yongin-si (KR); Hee-jean Kim, Yongin-si (KR); Dae-jong Lee, Hwaseong-si (KR); Yong-seok Jang, Hwaseong-si (KR); Yong-tae Kim, Suwon-si (KR)

(72) Inventors: Jae-jun Lee, Suwon-si (KR); Moon-seok Jang, Seoul (KR); Hong-seok Park, Anyang-si (KR); Yu-sung Joo, Yongin-si (KR); Hee-jean Kim, Yongin-si (KR); Dae-jong Lee, Hwaseong-si (KR); Yong-seok Jang, Hwaseong-si (KR); Yong-tae Kim, Suwon-si (KR)

(73) Assignee: SAMSUNG ELECTRONICS CO., LTD., Suwon-si (KR)

(21) Appl. No.: 13/980,679

(22) PCT Filed: Jan. 11, 2012
(86) PCT No.: PCT/KR2012/000271

§ 371 Date: Jul. 19, 2013

Related U.S. Application Data
(60) Provisional application No. 61/434,107, filed on Jan. 19, 2011.
(60) Provisional application No. 61/450,818, filed on Mar. 9, 2011.

(30) Foreign Application Priority Data
Dec. 2, 2011 (KR) 10-2011-0128644

(51) Int. Cl. H04N 13/00

(52) U.S. Cl. CPC H04N 13/0051
USPC 348/43

(57) ABSTRACT

A reception device is provided. The reception device includes: a first receiver receiving a first real-time transport stream via a broadcast network; a second receiver receiving a second real-time transport stream via a communication network; a delay processor delaying at least one of the first and second real-time transport streams for synchronization; a first detector detecting first data from the first real-time transport stream; a second detector detecting second data from a second real-time transport stream; a signal processor combining the first data and the second data so as to constitute multimedia content; and a playing unit playing the multimedia content.

### CROSS-REFERENCE TO RELATED PATENT APPLICATION

This application is a National Stage of International Application No. PCT/KR2012/000271 filed Jan. 11, 2012, and claims priority from Korean Patent Application No. 10-2011-0128644 filed on Dec. 2, 2011, in the Korean Intellectual Property Office, U.S. Provisional Application No. 61/434,107 filed Jan. 19, 2011, and U.S. Provisional Application No. 61/450,818 filed on Mar. 9, 2011, the disclosures of which are incorporated herein in their entirety by reference.

### BACKGROUND

1. Field

Apparatuses and methods consistent with the exemplary embodiments relate to a reception device for receiving a plurality of transport streams, and a transmission device and a method for playing multimedia content, and more specifically, to a reception device and a transmission device which transmit and receive one multimedia content through different paths, and a playback method thereof.

2. Related Art

With recent technological developments, various types of electronic devices such as televisions (TVs) are developed and distributed.

As the performance of the TVs have recently been enhanced, multimedia content such as three-dimensional (3D) content is provided. Because 3D content includes left-eye images and right-eye images, content size is bigger than that of related art two-dimensional (2D) content.

However, the transport bandwidth used in a broadcasting network is limited. To provide 3D content in a unified broadcasting network, there is a problem that resolution needs to be reduced and screen quality deteriorates.

To overcome this problem, technology whereby left-eye images and right-eye images are transmitted through different paths and combined in a reception device to generate 3D content, has been suggested. Therefore, searches are performed on a method for previously downloading at least one of the images at unreal time and playing the downloaded images.

However, the above method has a problem related to the security of previously downloaded content, and also has a difficulty in that high capacity storage devices should be included to store the downloaded content. Further, in a live environment, because unreal time data cannot be previously downloaded, a problem may occur in that delay cannot be avoided.

Thus, new technology in which multimedia content can be played efficiently in a reception device is necessary.

### SUMMARY

According to an exemplary embodiment, there is provided a reception device which receives a plurality of real-time transport streams transmitted through different paths and plays multimedia content, a method for playing the multimedia content, and a transmission device which transmits the transport streams.

According to an exemplary embodiment, a reception device is provided, which may include a first receiver configured to receive a first real-time transport stream through a broadcasting network, a second receiver configured to receive a second real-time transport stream through a communication network, a delay manager configured to synchronize, by delaying at least one of the first and second real-time transport streams, a first detector configured to detect a first data from the first real-time transport stream, a second detector configured to detect a second data from the second real-time transport stream, a signal processor configured to generate a multimedia content by combining the first and second data, and a playback device configured to play the multimedia content.

According to another aspect of the exemplary embodiment, the first real-time transport stream may include address information, and the second receiver is configured to receive metadata files from the server by accessing the server within the communication network with the address information and receive the second real-time transport stream by using the metadata files, and the metadata files may include information regarding sources of the second real-time transport stream.

According to another aspect of the exemplary embodiment, the address information may be recorded on at least one of a reserved area within a Program Map Table (PMT) of the first real-time transport stream, a descriptor area within the PMT, a reserved area of the first real-time transport stream, a private data area of the first real-time transport stream, a reserved area within a Packetized Elementary Stream (PES) of the first real-time transport stream, a private data area within the PES of the first real-time transport stream, a user area within an Elementary Stream (ES) header, a private area within the ES header, Supplemental Enhancement Information (SEI) if the address information is based on a H.264 standard.

According to aspect of the exemplary embodiment, the second data may include a plurality of data units having at least one of a size established adaptively according to a state of the communication network.

According to another aspect of the exemplary embodiment, one of the first data and the second data may include a left-eye image and the other may include a right-eye image, and the multimedia content is 3D content.

According to another aspect of the exemplary embodiment, the first real-time transport stream may include first synchronizing information, the second real-time transport stream may include second synchronizing information, and the first and second synchronizing information may include at least one of content start information to inform a start point of the multimedia content, a difference value of time stamps between the first data and the second data, and a frame index.

According to another aspect of the exemplary embodiment, the reception device may additionally include a controller configured to control the signal processor to compensate at least one of the time stamps in each frame included in the first data and the time stamps in each frame included in the second data based on the first and second synchronizing information, and generate the multimedia content by combining each frame of the first and second data.

The first real-time transport stream may include a first synchronizing information, the second real-time transport stream may include a second synchronizing information, and the first and second synchronizing information may be time code information of image frames.

According to another exemplary embodiment, a transmission device is provided, which comprises a stream generator configured to generate a first real-time transport stream including a first data and a first synchronizing information, an output configured to output the first real-time transport stream, and a controller configured to control the output to delay output timing of the first real-time transport stream adjusted for output timing of other transmission devices which output a second real-time transport stream. The second real-time transport stream may include a second data and second synchronizing information, the first and second data may be data to generate a multimedia content, and the first and second synchronizing information may be information transmitted for synchronization of the first and second data.

Alternatively, a transmission device may include a stream generator configured to generate a first real-time transport stream comprising a first data and address information, and an output configured to output the first real-time transport stream, in which the address information may be address information regarding metadata files that a second data generating multimedia content with the first data can be obtained on a communication network.

According to an exemplary embodiment, a method of playing multimedia content at a reception device is provided, the method comprises receiving a first real-time transport stream from a broadcasting network, receiving a second real-time transport stream from a communication network, delaying at least one of the first and second real-time transport streams and synchronizing the first transport stream and the second transport stream, detecting a first data from the first real-time transport stream and detecting a second data from the second real-time transport stream, generating a multimedia content by combining the first data and the second data, and playing the multimedia content.

According to another aspect of the exemplary embodiment, the receiving the second real-time transport stream through the communication network may include detecting address information included in the first real-time transport streams, receiving metadata files from a server by accessing the server within the communication network with the address information, and receiving the second real-time transport stream by accessing sources of the second real-time transport stream with the metadata files.

According to another aspect of the exemplary embodiment, one of the first data and the second data may include a left-eye image and the other of the first data and the second data may include a right-eye image, and the multimedia content is 3D content.

According to another aspect of the exemplary embodiment, the second data may include a plurality of data units having at least one of sizes established adaptively according to a state of the communication network.

According to another aspect of the exemplary embodiment, the first real-time transport stream may include first synchronizing information, the second real-time transport stream comprises second synchronizing information, and the first and second synchronizing information may include at least one of content start information to inform start point of the multimedia content, difference value of time stamps between the first data and the second data, frame index, and time code.

According to various exemplary embodiments, real-time transport streams can be received through a plurality of different paths and synchronized with each other. Thus, high quality of multimedia content can be played.

### BRIEF DESCRIPTIONS OF THE DRAWINGS

The above and/or other aspects of the present inventive concept will be more apparent by describing certain exemplary embodiments of the present inventive concept with reference to the accompanying drawings, in which:

FIG. 1 illustrates a multimedia content transmitting and receiving system according to an exemplary embodiment,

FIG. 2 illustrates a reception device according to an exemplary embodiment;

FIG. 3 illustrates a process of synchronizing and playing a transport stream in the reception device;

FIG. 4 illustrates a process of synchronizing with minimized delay time;

FIG. 5 illustrates an operation of receiving a plurality of real-time transport streams through a broadcasting network and a communication network;

FIGS. 6 to 9 illustrates methods of delivering address information in HTTP methods;

FIG. 10 illustrates constitution of an HTTP stream including media presentation description (MPD) files;

FIG. 11 illustrates constitution of an HTTP stream including synchronizing information;

FIG. 12 illustrates a transmission process which divides and transmits multimedia content into a plurality of streams;

FIG. 13 illustrates a process of obtaining a transport stream in a multimedia content transmitting and receiving system;

FIG. 14 illustrates constitution of stream in which synchronizing information is included in program map table (PMT);

FIG. 15 illustrates the constitution of a PMT in which synchronizing information is recorded;

FIG. 16 illustrates a method of delivering synchronizing information by using a transport stream (TS) adaptation field;

FIG. 17 illustrates a method of delivering synchronizing information by using a program elementary stream (PES) header;

FIG. 18 illustrates a method of delivering synchronizing information by using event information table (EIT);

FIG. 19 illustrates a method of delivering synchronizing information by using a private stream;

FIG. 20 illustrates a method of delivering a frame index by using PMT;

FIG. 21 illustrates a method of delivering a frame index by using a private stream;

FIG. 22 illustrates a plurality of transport streams allocated with time codes respectively;

FIGS. 23 to 26 illustrate various examples regarding a method of transmitting respective synchronizing information;

FIGS. 27 to 29 are block diagrams of a reception device according to various exemplary embodiments;

FIG. 30 is a flowchart which illustrates a method of playing multimedia content according to an exemplary embodiment; and

FIG. 31 is a flowchart which illustrates a method of obtaining a second real-time transport stream by using address information included in a first real-time transport stream.

### DETAILED DESCRIPTION OF EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the exemplary embodiments. Accordingly, it is apparent that the exemplary embodiments may be carried out without those specifically defined matters. Also, well-known functions or constructions are not described in detail since they would obscure the exemplary embodiments with unnecessary detail.

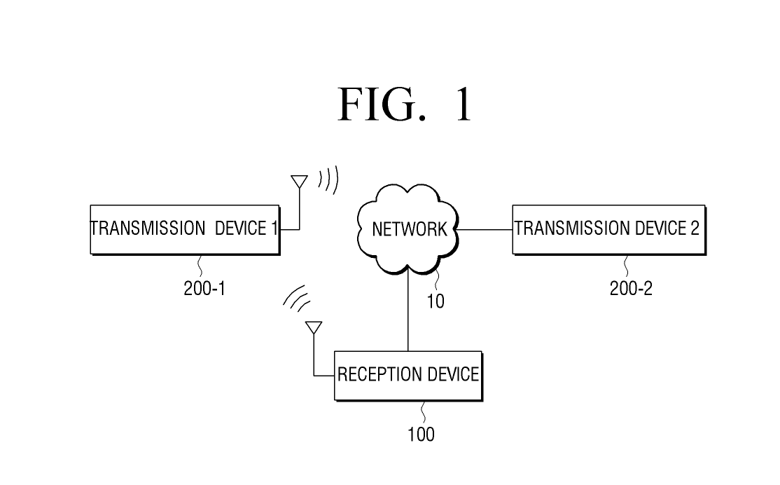

FIG. 1 illustrates constitution of a multimedia content transmitting and receiving system according to an exemplary embodiment. Referring to FIG. 1, the multimedia content playing system includes a plurality of transmission devices 200-1, 200-2 and a reception device 100.

The transmission device 1, 200-1, and the transmission device 2, 200-2, transmit different signals through different paths. Referring to FIG. 1, the transmission device 1 200-1 transmits first signals through a broadcasting network and the transmission device 2 200-2 transmits second signals through a communication network 10.

The first and second signals may be arranged with a real-time transport stream which respectively include different data from each other. For example, with regard to 3D content, left-eye or right-eye images may be included in a first real-time transport stream and transmitted through the broadcasting network, and other images may be included in a second real-time transport stream and transmitted through the communication network. The first data included in the first signals and the second data included in the second signals may be implemented as various types of data as well as left-eye and right-eye images. For example, the data may be divided into video data and audio data, video data and subtitle data, or other additional data, and transmitted as first and second real-time transport streams respectively.

The reception device 100 receives real-time transport streams which are respectively transmitted from the transmission devices 1 and 2, and performs buffering. During the process, at least one of the real-time transport streams are delayed and synchronized with each other.

The second real-time transport stream transmitted through the communication network 10 may be streamed with various types of streaming methods such as real time protocol (RTP) or hypertext transfer protocol (HTTP). A method for obtaining the second real-time transport stream will be described below.

Further, the first real-time transport stream includes first synchronizing information along with the first data and the second real-time transport stream includes second synchronizing information along with the second data.

Various information may be used as first and second synchronizing information. Specifically, at least one of content start information to inform start point of multimedia content, difference value of time stamps between the first data and the second data, frame index, time code information, coordinated universal time (UTC) information, and frame count information may be used as synchronizing information.

According to the MPEG standard, the transport stream for transmitting broadcasting data may include a program clock reference (PCR) and a presentation time stamp (PTS). PCR indicates reference time information so that a reception device such as a set-top box or a television (TV) according to the MPEG standard, adjusts the time standard to that of a transmission device. The reception device adjusts a value of a system time clock (STC) according to the PCR. The PTS indicates a time stamp to inform the playing time for synchronizing image and voice in a broadcasting system according to the MPEG standard. This will be referred herein as a time stamp. When different signals are transmitted through the different transmission devices 200-1, 200-2, the PCR may be different according to features of the transmission devices 200-1, 200-2. Therefore, even if playing may be performed according to the time stamp adjusted for PCR, synchronizing may not be performed. Considering this, the system may include synchronizing information in each of real-time transport streams which are transmitted through different paths. The reception device 100 may adjust the time stamp of an image frame included in each of transport streams using the synchronizing information or sync-play by directly comparing the synchronizing information.

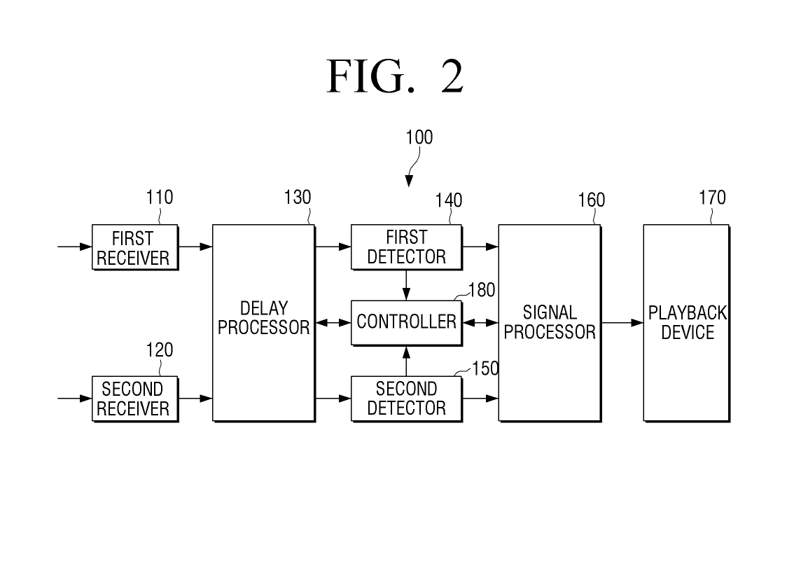

FIG. 2 is a block diagram of a reception device 100 according to an exemplary embodiment. Referring to FIG. 2, the reception device 100 includes a first receiver 110, a second receiver 120, a delay processor 130, a first detector 140, a second detector 150, a signal processor 160, a playback device 170 and a controller 180.

The first receiver 110 receives the first real-time transport streams which are transmitted through the broadcasting network. The first receiver 110 may be implemented to include an antenna, a tuner, a demodulator, and an equalizer (not shown).

The second receiver 120 receives the second real-time transport stream by accessing external sources through the communication network. The second receiver 120 may include a network interface card (not shown).

The delay processor 130 delays at least one of the first and second real-time transport streams and synchronizes the first and second transport streams. The delay processor 130 may delay transport stream by using various methods such as personal video recorder (PVR), time shift, or memory buffering.

When using memory buffering, the delay processor 130 may delay a real-time transport stream by using a buffer separately mounted within the reception device 100 or a buffer mounted internally within the delay processor 130. For example, when the first real-time transport streams are first received and the second real-time transport streams are not yet received, the delay processor 130 stores and delays the first real-time transport streams on the buffer. In this situation, when the second real-time transport streams are received, the delay processor 130 reads the delayed first real-time transport streams from the buffer and provides them with the second real-time transport streams to the first and second detectors.

The delay processor 130 may analyze each stream so as to adjust the timing of providing the first and second real-time transport streams to the first and second detectors 140, 150, respectively. In other words, the delay processor 130 may analyze the stream to determine how much delay is provided to at least one of the first and second real-time transport streams. For example, the delay processor 130 may confirm parts of the streams to be synchronized with each other in the first and second real-time transport streams by using information such as content start information, time stamp difference value, or time stamps regarding each stream. Further, the delay processor 130 may confirm parts of the streams to be synchronized with each other by comparing information such as the frame index or the time code of the two streams.

The delay processor 130 adjusts the delay of the streams so that the timing of providing the confirmed parts to the first and second detectors 140, 150 can be matched with each other.

Information such as content start information, time stamp difference value, frame index and time code may be the synchronizing information, and these may be received as being included in each stream or received in a form of a private stream. The delay processor 130 may determine the duration of delay by using the synchronizing information, and delay the stream according to the determining results.

The first detector 140 detects the first data from the first real-time transport stream and the second detector 150 detects the second data from the second real-time transport stream. The detectors provide the first and second data to the signal processor 160.

The signal processor 160 generates multimedia content by combining the first and second data. Specifically, when the first data is video data and the second data is audio data, the signal processor 160 decodes each data and provides the result to a display and a speaker within the playback device 170 respectively. Therefore, the two data may be outputted at the same time.

Further, when the first data is a left-eye image and the second data is a right-eye image, the signal processor 160 may process data variously according to 3D display methods. In the case of a polarized type of display, the signal processor 160 may generate one or two frames by alternately arranging part of the synchronized left-eye and right-eye images. Therefore, corresponding frames may be outputted through a display panel to which lenticular lens or a parallax barrier is added. In the case of a shutter glass type, the signal processor 160 may alternately arrange the left-eye and right-eye images, and consecutively display the images on a display panel.

The playback device 170 plays multimedia content processed in the signal processor 160. The playback device 170 may include at least one of the display and the speaker according to types of the reception device 100, or may be implemented as an interface connected with an external display apparatus.

The controller 180 may delay a first-received stream by controlling the delay processor 130. Further, the controller 180 may control the signal processor 160 to perform the operation of playing the multimedia content by combining the first and second data.

Specifically, when synchronizing information is included in each of the first and second real-time transport stream, the controller 180 may control the signal processor 160 to adjust at least one of a time stamp regarding each frame included in the first data and a time stamp regarding each frame included in the second data using the synchronizing information, and generate multimedia content by combining each frame of the first and second data according to the adjusted time stamp.

According to the exemplary embodiments, the controller 180 may directly compare a time code or a frame index without adjusting the time stamp and may control the signal processor 160 so that frames which have the same time codes or frame indexes can be played.

Besides, the controller 180 may control the operation of each unit included in the reception device 100.

The signal processor 160 and the controller 180 can perform synchronization jobs in which frames corresponding to each other can be sync-played by using synchronizing information included in the first and second real-time transport streams.

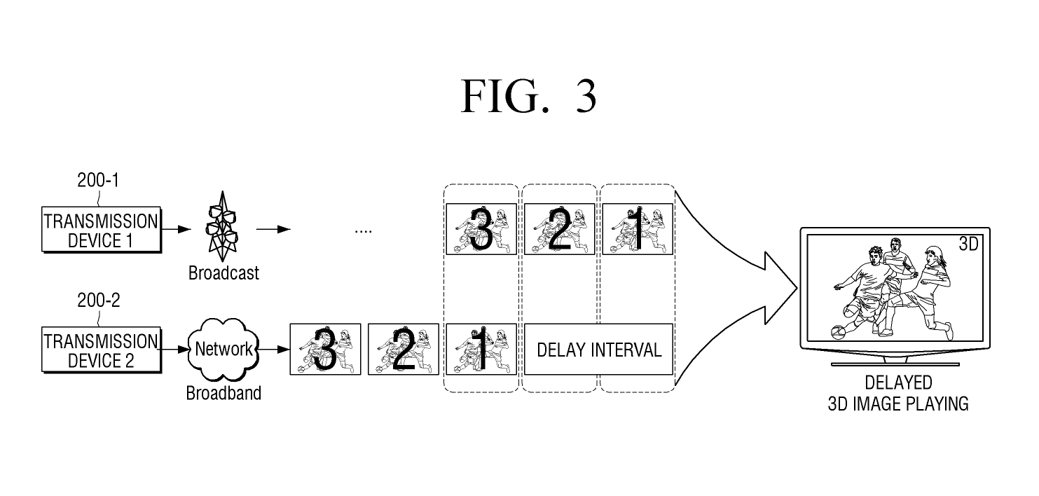

FIG. 3 illustrates a process for adjusting synchronization by delaying at least one of a plurality of real-time transport streams at the reception device of FIG. 2. Referring to FIG. 3, the transmission device 1 200-1 transmits a real-time transport stream through the broadcasting network and the transmission device 2 200-2 transmits a real-time transport stream through the communication network. Even when the transmission time points are the same, one of the two streams can arrive first due to environmental differences between the broadcasting network and the communication network. FIG. 3 illustrates that the first real-time transport stream transmitted through the broadcasting network is delayed for two frames and synchronized with the second real-time transport stream. Therefore, 3D images delayed for about two frames are played.

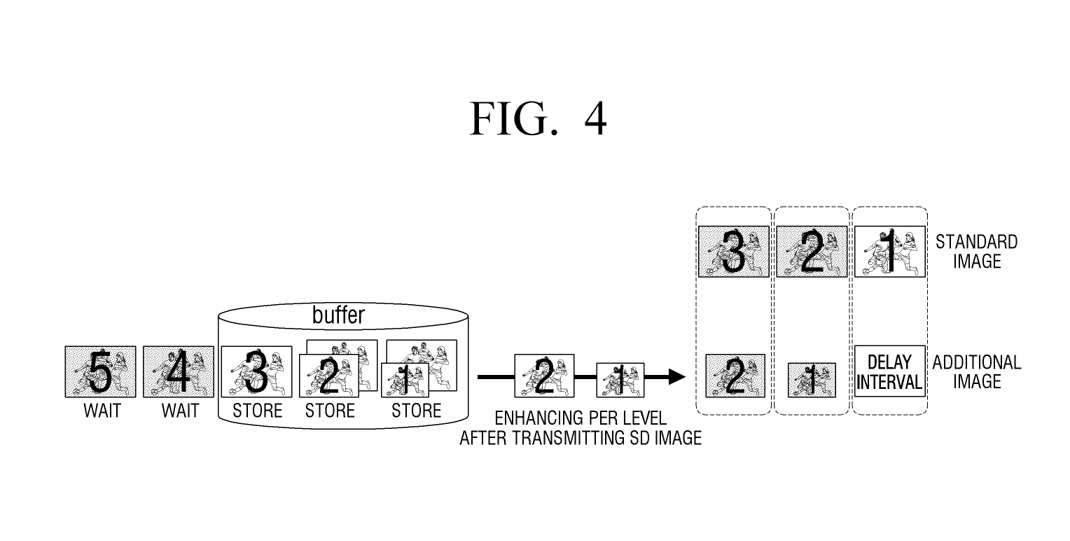

FIG. 4 illustrates another exemplary embodiment of reducing delay time. Referring to FIG. 4, in the transmission device 2 200-2 for transmitting the second real-time transport stream, the images to be transmitted are divided into various sizes of access units, delay time is reduced by first transmitting the smallest size of image, and screen quality of the images to be transmitted is enhanced by considering the communication situation. FIG. 4 illustrates that a standard definition (SD) level frame is transmitted as first frame and a high definition (HD) level frame is transmitted as the second frame. Comparing with FIG. 3, the delay time is reduced for about one frame.

The size of the image resolution may be different according to the status of the communication network. In other words, when the communication bandwidth is insufficient or the communication speed is low, the smallest resolution of data is transmitted first, and the resolution of the data can be gradually increased as illustrated in FIG. 4 to minimize the delay time. Therefore, the second real-time transport stream includes a plurality of data units which have at least one size which is adaptively established according to the state of the communication network. Audio data, as well as video data, may be transmitted by determining the data size differently according to the state of the communication network. Thus, the reception device 100 may perform synchronization while minimizing delay time of the plurality of real-time transport streams.

As described above, the second real-time transport stream may be transmitted and received by using protocols such as RTP or HTTP.

When using HTTP, metadata files should be provided to obtain the second real-time transport stream.

Streaming by using HTTP is a streaming method which minimizes loads of the server by counting on clients' processing. The second receiver 120 completes streaming by using transmission requests for HTTP files or parts of the files. The transmitting side should put files which are compressed at several transmission rates with regard to one content on the server to adaptively respond to changes in transmission rates of the network. Further, in order to quickly respond to changes in the state of the network, whole content files should be divided into plural items and the plural items should be stored as files. The transmitting side should provide metadata to inform how the divided plural files can be loaded, and play multimedia content at the receiving side.

Metadata is information to inform where multimedia content can be received. Metadata files may be divided variously according to the types of HTTP based streaming.

Regarding a smooth streaming method, ISM (Internet information service (11S) smooth streaming Media) files are used as metadata files.

Regarding an internet engineering task force (IETF) HTTP live streaming method, m3v8 files are used as metadata files. Regarding an adaptive HTTP streaming Rel. 9 method which is applied in 3GPP, an adaptive HTTP streaming Rel. 2 method which is applied in OIPF, and a dynamic adaptive streaming over HTTP method which is applied in MPEG, media presentation description (MPD) may be used as metadata files.

Metadata files may include information which clients should previously recognize such as position on content time corresponding to the divided plural files, URL of sources providing corresponding files, and sizes, and so on.

According to an exemplary embodiment, address information regarding sources that metadata files can be obtained may be included in the first real-time transport stream.

Meanwhile, when using RTP, processes of receiving metadata and requesting stream with metadata information are deleted. However, processes of delay-processing parts of stream and synchronizing parts of stream by using synchronizing information may be applied uniformly to the exemplary embodiment using RTP.

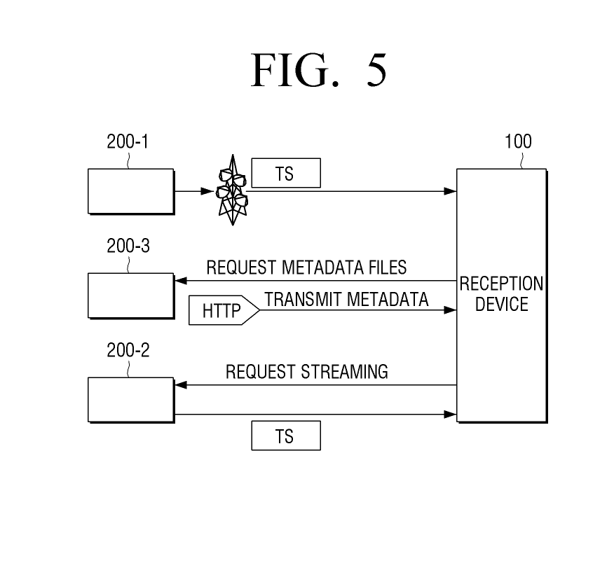

FIG. 5 is provided to explain a method of providing metadata files according to an exemplary embodiment. Referring to FIG. 5, the transmission device 1 200-1 transmits the first real-time transport stream (TS) including address information through the broadcasting network.

The reception device 100 confirms information regarding the server which provides metadata files by detecting address information. When the reception device 100 having the constitution of FIG. 2 is implemented, the first detector 140 may detect address information and provide the address information to the second receiver 120.

The second receiver 120 accesses server 200-3 within the communication network by using address information. The server 200-3 transmits metadata files according to a request of the second receiver 120. The second receiver 120 accesses second real-time transport stream source 200-2 by using the metadata files, requests and receives transmission of the second real-time transport stream. As described above, the metadata files include information regarding sources of the second real-time transport stream.

Address information may be included and transmitted in various areas of the first real-time transport stream. According to a dynamic adaptive streaming over HTTP method (DASH), address information may be URL information such as Hybrid3DURL or Hybrid3DMetaURL. Address information may be recorded and transmitted in various sections of the first real-time transport stream.

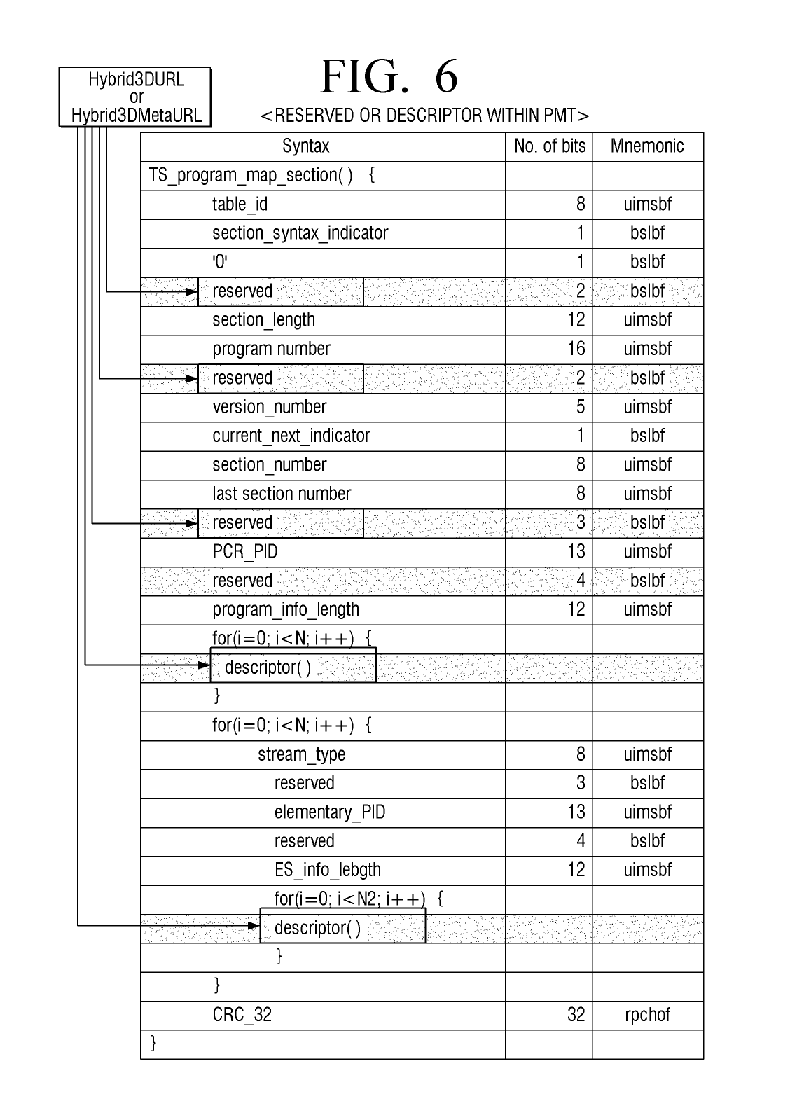

FIGS. 6 to 9 illustrate examples in which address information may be transmitted by using various areas within the first real-time transport stream.

Referring to FIG. 6, address information may be recorded in reserved areas or descriptor areas within the program map table (PMT).

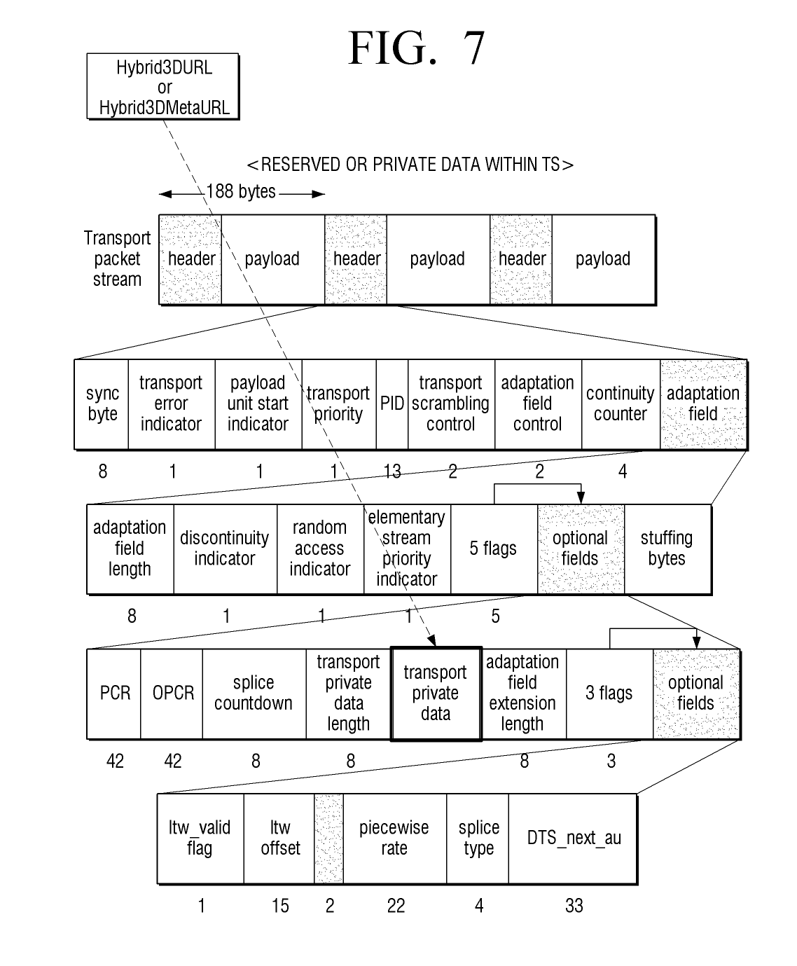

Further, referring to FIG. 7, address information may be recorded in reserved areas of the first real-time transport stream or in private data areas of the first real-time transport stream.

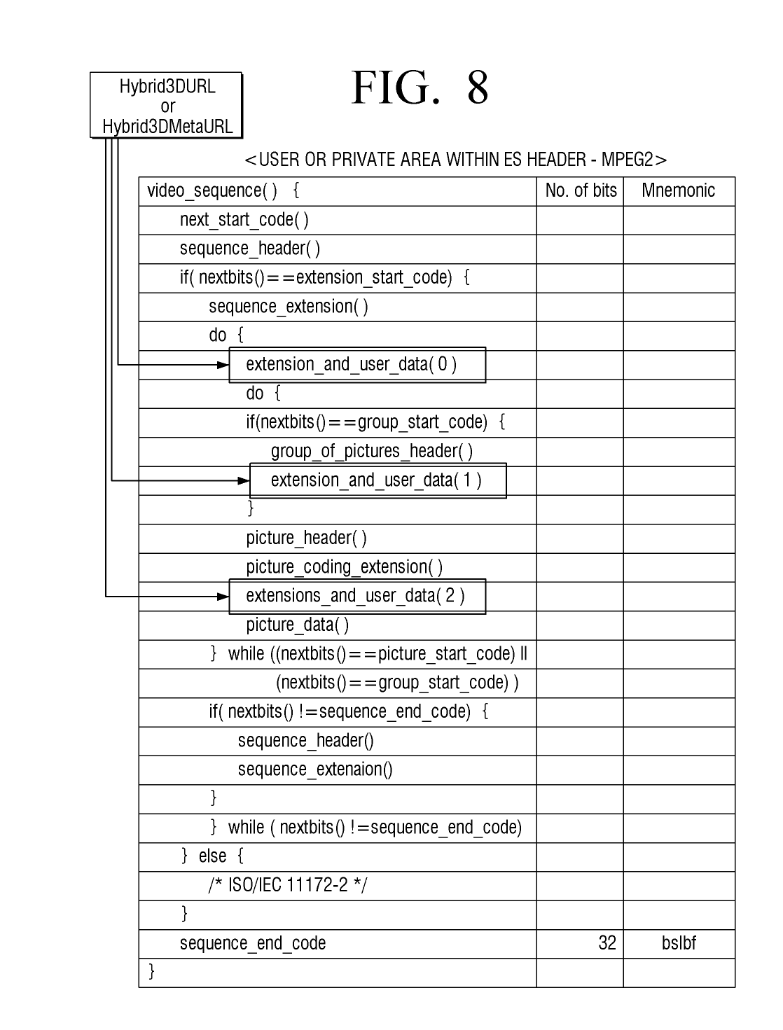

Further, referring to FIG. 8, address information may be recorded in user data areas or private areas within the ES header.

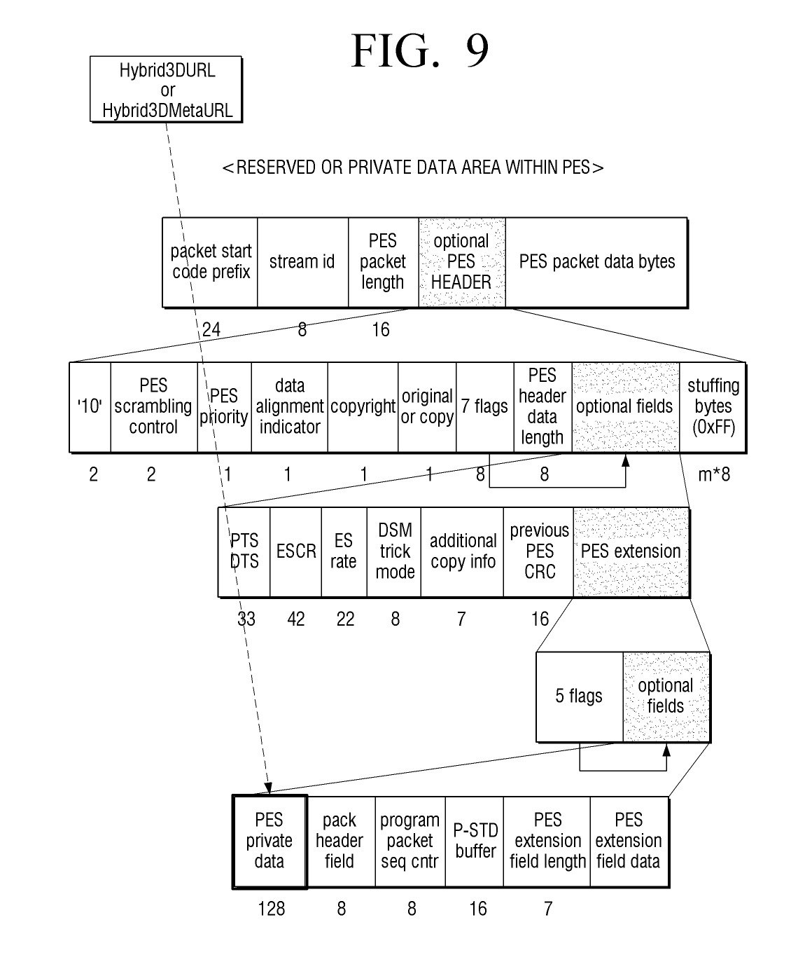

Further, referring to FIG. 9, address information may be recorded in reserved areas or private data areas within the program elementary stream (PES) of the first real-time transport stream.

Besides, according to H.264 standard, address information may be recorded in at least one of supplemental enhancement information (SEI).

Such address information indicates sources from which metadata files can be obtained, i.e., address information regarding server.

The reception device 100 accesses a corresponding source by using address information included in the first real-time transport stream, and receives metadata files from the corresponding source. When another separate server to manage metadata files is used, metadata files may be updated more easily.

Metadata files may include packet identifier (PID) information basically. Additionally, respective link information provided for interoperateing services with other channels may be included. Such link information may be link_original_network_id which is original network ID of 3D additional image service connected with corresponding channel, linked_carrier_frequency which is a wireless frequency value to provide 3D image service channel or additional image service, link_logical_channel_number which is logical channel number to provide 3D additional image service connected with corresponding channel, link_transport_stream_id which is an identifier to identify the transport stream on the network, link_service_id which is an identifier to identify a service within the transport stream, link_url_indicator which is an identifier to inform of URL information, link_source_URL which is a URL address to provide 3D adding image and information of corresponding content, and link_service_start_time which is a time when linking service of NRT service or downloading is provided.

Besides, metadata files may include modulation information of a provided broadcasting stream. Modulation information may be SCTE_mode_{—}1:64-QAM, SCTE_mode_{—}2:256-QAM, ATSC(8VSB), and AVSB(16VSB).

As described above, if the second real-time transport stream is transmitted through the communication network, the transmitted second real-time transport stream should be synchronized with the first real-time transport stream. Therefore, information which can adjust playing time of the second data included in the second real-time transport stream is requested. Such information may be added to the metadata files. Specifically, information such as linkedContent indicating that content needs to be synchronized and played, playableRestriction indicating that content request is impossible through the streaming channel before a time point of sync-playing, and designatedPlayTime providing correct time of playing start or start time offset may be included and transmitted in metadata files.

Herein, designatedPlayTime follows the UTC format. The reception device 100 limits playing of the second data before playing start time obtained by designatedPlayTime and performs sync-playing by using synchronizing information to sync-play.

Metadata files include synchronizing information. Such information may be added as a component of a period level. Synchronizing information may be startPTS, PTSdiff, and frame index.

startPTS indicates a time stamp at the point where multimedia content starts. startPTS may be called as content start information since it is information indicating a start point of multimedia content. PTSdiff indicates a difference value between a time stamp allocated on each frame of the first real-time transport stream and a time stamp allocated on each frame of the second real-time transport stream.

Frame index indicates the index of each image frame within the second real-time transport stream. When the frame index is divided into plural periods, the frame index indicates the frame index at starts point of each period. Further, the standard of index becomes the first frame of the streaming file, in which index=1. Consecutively, frame index is allocated. Index information is established uniformly with the frame index of image frame transmitted from the first real-time transport stream.

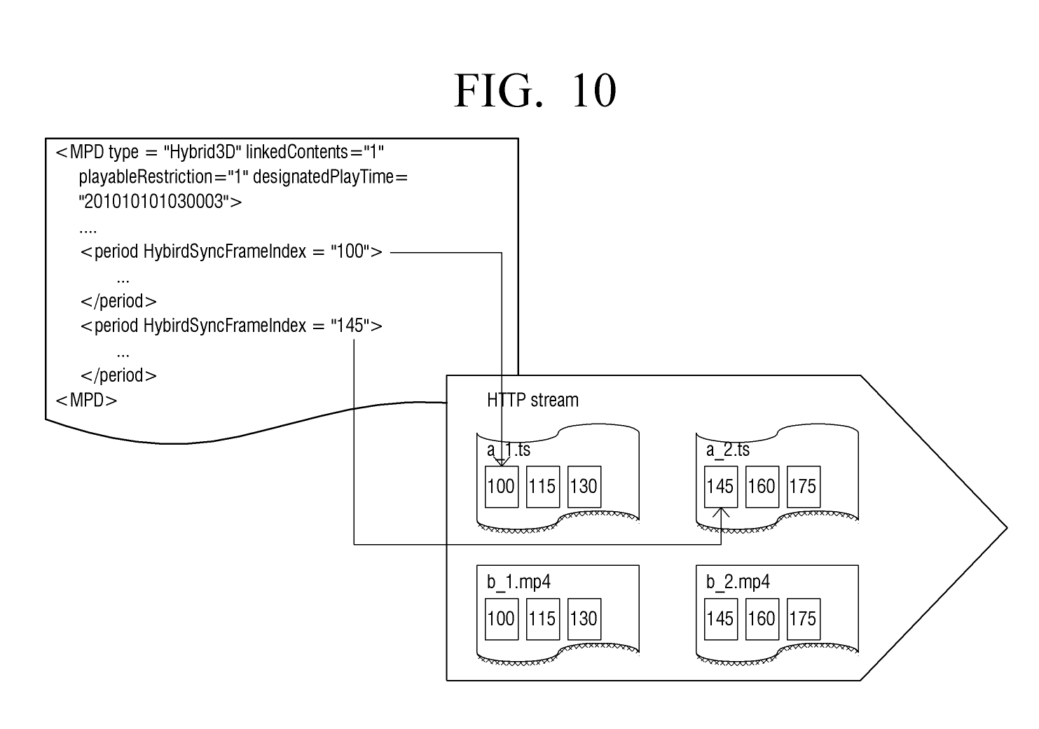

FIG. 10 illustrates an example of a method for expressing MPD files which includes frame index information. Referring to FIG. 10, frame index information is included in MPD files. When different signals are received through different paths, time stamps of data to implement uniform content may be different due to the time difference while signal-processing and transmitting. At this process, when frame index information is recognized, the reception device 100 may compensate time stamps of frames having uniform frame index in the first and second data to be the same value. Further, frame indexes are compared with each other and played to perform synchronization if they are the same.

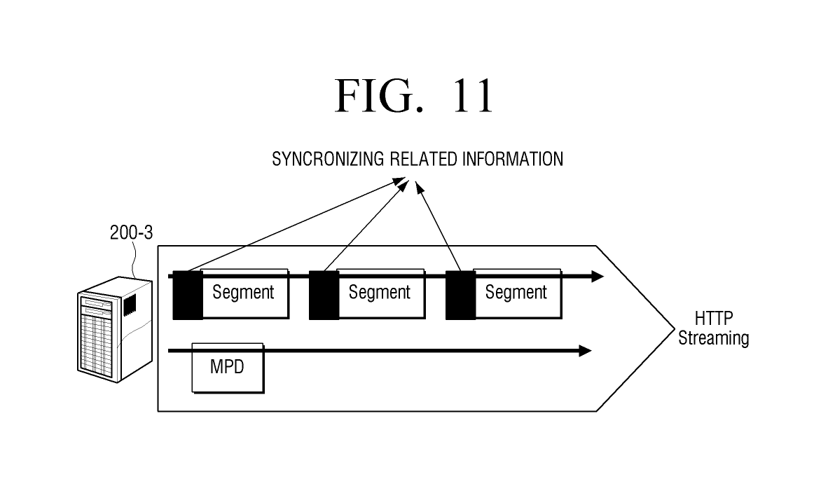

FIG. 11 illustrates an HTTP streaming structure which divides and transmits synchronizing information on a segment basis. Referring to FIG. 11, the transmission device 200-3 may provide synchronizing information with MPD. As described above, synchronizing information may include content start information to inform the start point of multimedia content, difference value of time stamps between the first and second data, and frame index.

Such synchronizing information may be included and transmitted in each of the first and second real-time transport streams. However, when being included in metadata files, the synchronizing time point can be recognized before transmitting the second real-time transport stream.

Thus, the first and second data respectively included in the first and second real-time transport stream are processed together to generate one multimedia content. Therefore, the first and second data are suggested to be produced together.

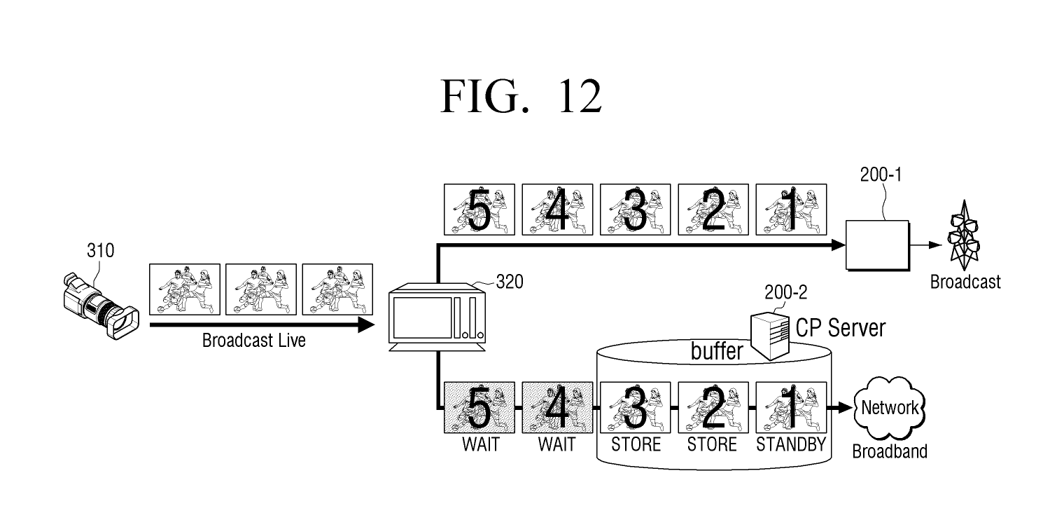

FIG. 12 illustrates a transmitting process of producing the first and second data together and transmitting the first and second data through different paths. Referring to FIG. 12, multimedia content photographed by one camera 310 is divided into the first and second data. The divided data are respectively encoded by an encoder 320 and respectively provided to the different transmission devices 200-1, 200-2. Thus, the first data which corresponds to a standard image is encoded by the encoder 320 and provided to the transmission device 1 200-1. The transmission device 1 200-1 converts corresponding data into transport stream and broadcasts in RF signal format through the broadcasting network.

The second data which corresponds to additional images is divided and encoded on an access unit basis and provided to the transmission device 2 200-2. The transmission device 2 200-2 buffers corresponding data and transmits the corresponding data to the reception device 100 through the communication network. The transmission device 2 200-2 may be a content provider server. The transmission device 2 200-2 stores data provided from the encoder 320 by buffering size. When there is a request of the reception device 100, requested data is provided to the reception device 100.

Although FIG. 12 illustrates one encoder 320, plural encoders 320 may be implemented based on the amount of data.

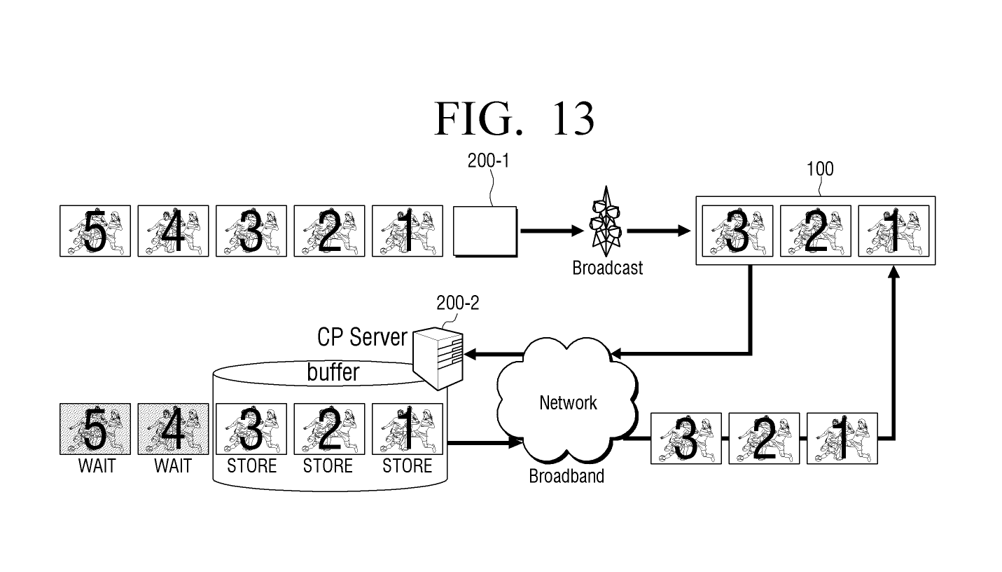

FIG. 13 illustrates a process of transmitting and receiving the first and second data. Referring to FIG. 13, the first real-time transport stream including the first data is broadcasted by the transmission device 1 200-1 and transmitted to the reception device 100. After detecting address information included in the first real-time transport stream, the reception device 100 obtains metadata files by using corresponding address information. The reception device 100 requests the second data by accessing the transmission device 2 200-2 with the metadata files.

The transmission device 2 200-2 transmits the second real-time transport stream including the second data to the reception device 100 according to the request. The second data includes a plurality of data units which have at least one size adaptively established according to the state of the communication network. In other words, the transmission device 2 200-2 adaptively determines the size of the second data by considering the state of the communication network, specifically, communication bandwidth or communication speed.

When the second data is video data, the resolution of the image stored in the buffer may be determined by considering the communication bandwidth. The communication bandwidth may be measured while transmitting and receiving requests between the reception device 100 and the transmission device 2 200-2. The transmission device 2 200-2 selects images optimized for the network state such as SD level or HD level images by considering the measured bandwidth and transmits the images to the reception device 100. Therefore, delay may be minimized.

As described above, the first and second real-time streams may include synchronizing information with data. Synchronizing information may be at least one of content start information, difference value of time stamps between the first and second data, frame index, time code information, UTC information, and frame count information.

In an exemplary embodiment where content start information is used as synchronizing information, the reception device 100 recognizes a start point of multimedia content by using the content start information. When the reception device 100 is implemented as in FIG. 2, the signal processor 160 may perform such operation.

The signal processor 160 may compare the start point with a time stamp of the frame included in the first data and a time stamp of the frame included in the second data respectively. According to the comparing results, the frame index of each data may be detected, and synchronization may be performed with the detected frame index.

Even when the time stamp of the L2 frame in the first signals and the time stamp of the R2 frame in the second signals are different from each other, the L2 frame and the R2 frame are synchronized with each other to generate n+1 frames if the difference between the time stamp of the L2 frame and the start point of content which the first and second signals generate is the same as the difference between the time stamp of the R2 frame and the start point.

The signal processor 160 may detect the frame index by comparing content start information with the time stamp. For example, in the first signals, if content start information (PTSH_Start) is 100 and time stamp (PTS) of left-eye image L1 frame is 100, PTS−PTSH_Start=0. If PTS of next left-eye image L2 frame is 115, PTS−PTSH_Start=15. In this case, the signal processor 160 puts the time stamp interval as 15, and matches the L1 frame with the nth frame and the L2 frame with the n+1th frame. In the second signals, assume that content start information is 300, the time stamp of the R1 frame is 300, and the time stamp of the R2 frame is 330, the signal processor 160 puts the time stamp interval as 30, and matches the R1 frame with the nth frame and the R2 frame with the n+1th frame.

The signal processor 160 compensates the time stamp of the right-eye image frame or the left-eye image frame to be uniform, so that time stamps of the two frames can be matched.

The right-eye image frame of the frame is matched with a next frame of the left-eye image frame. The signal processor 160 compensates a time stamp of the right-eye image frame to be uniform with a time stamp regarding the next frame of the left-eye image frame and synchronizes the frames with each other.

According to another exemplary embodiment, the difference value between time stamps of the two data may be used as synchronizing information. In other words, first synchronizing information and second synchronizing information may respectively include a difference value between time stamps of the left-eye and right-eye images. In this case, the signal processor 160 compensates at least one of time stamps of the left-eye and right-eye images by considering the difference value and synchronizes the images with each other.

Content start information and time stamp difference information may be recorded in an event information table (EIT), a PMT, a private stream, and a transport stream header. Further, the above exemplary embodiments illustrate that real-time transport streams are transmitted. However, such synchronizing information may be recorded in a media header box (mdhd) or decoding time to sample box (stts) when the first data or the second data is transmitted as an MP4 file which is unreal-time stream. When being transmitted as an MP4 file, the signal processor 160 may calculate a frame rate by using time scale or time duration, and synchronize the playing time by comparing the calculated frame rate. Thus, time scale recorded in mdhd within the MP4 file is 25000 and data recorded within stts is 1000, 1000/25000 is calculated as the frame rate. Therefore, because a frame is played per 1/25 second, comparative play timing difference between the two signals may be recognized. The signal processor 160 may synchronize the two signals by using comparative play timing and start point.

According to another exemplary embodiment, frame index information may be used as synchronizing information. Frame index information indicates identifying information allocated to each frame. The signal processor 160 may perform compensation so that time stamps of frames having the same frame index can be uniform.

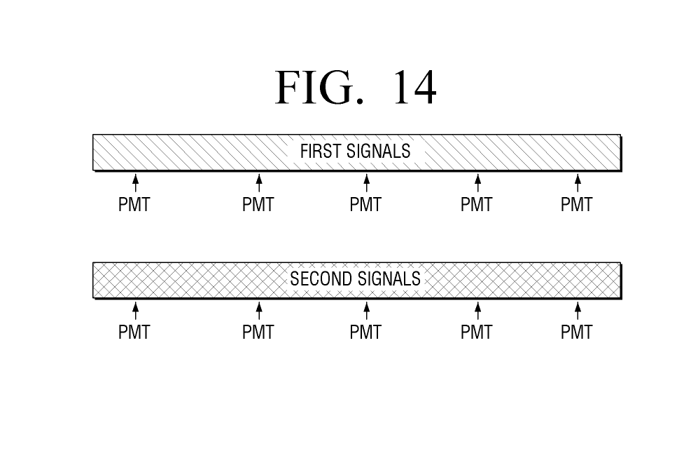

FIG. 14 illustrates the constitution of a stream including PMT. Referring to FIG. 14, PMT is included periodically within the first and second signals which are transmitted from the transmission devices 200-1, 200-2 respectively. Various synchronizing information such as the above described content start information, time stamp difference value, and frame index may be included and transmitted within the PMT.

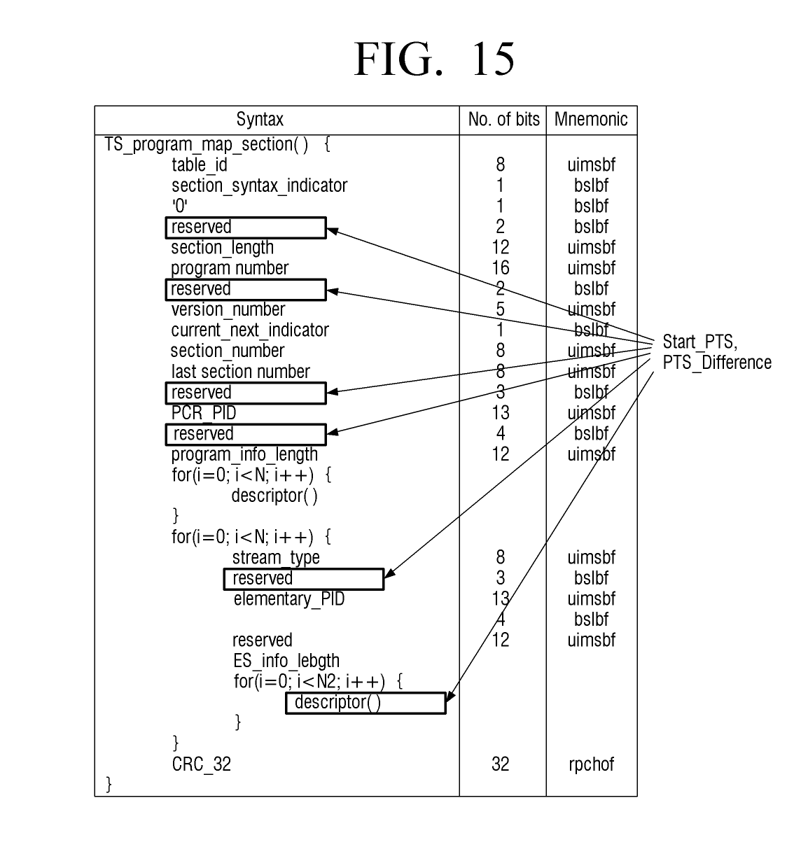

FIG. 15 illustrates a PMT structure. Referring to FIG. 15, respective synchronizing information may be transmitted by using a reserved area, a new descriptor, or an expanded area of a previous descriptor within the PMT.

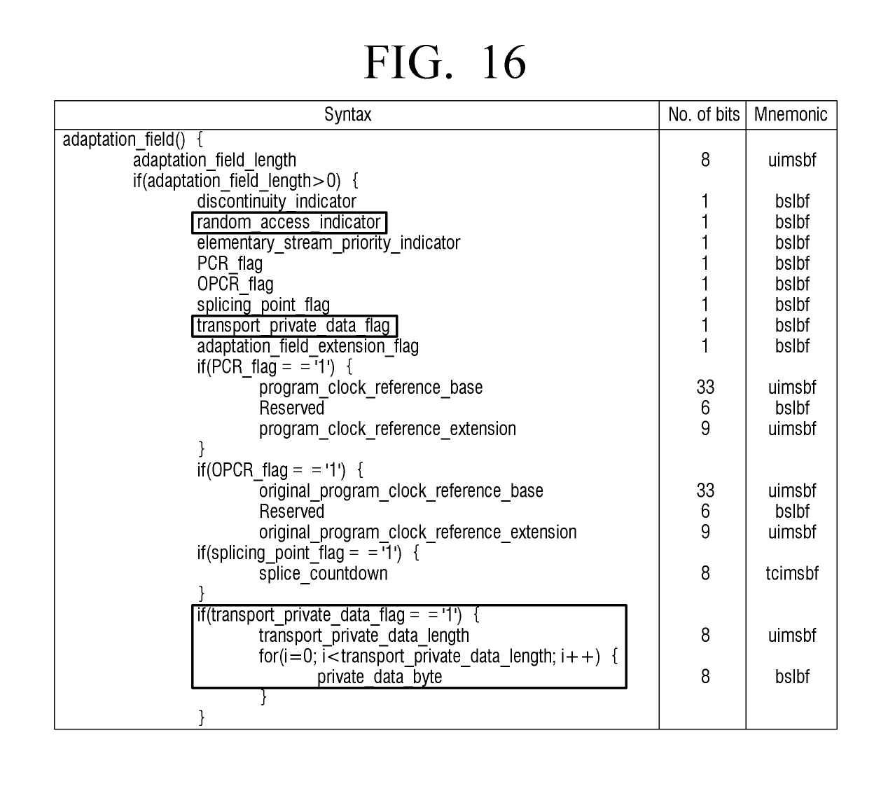

FIG. 16 illustrates a method of transmitting respective synchronizing information by using an adaptation field of the transport stream. In FIG. 16, random_access_indicator, transport_private_data_flag, and private_data_byte are included within the adaptation field. random_access_indicator is implemented as 1 bit, and indicates a start of a sequence header if being set as 1. transport_private_data_flag is also implemented as 1 bit, and indicates that private data is included over 1 byte if being set as 1. private_data_byte is implemented as 4 to 5 bytes, and may include synchronizing information such as content start information, time stamp difference value, and frame index.

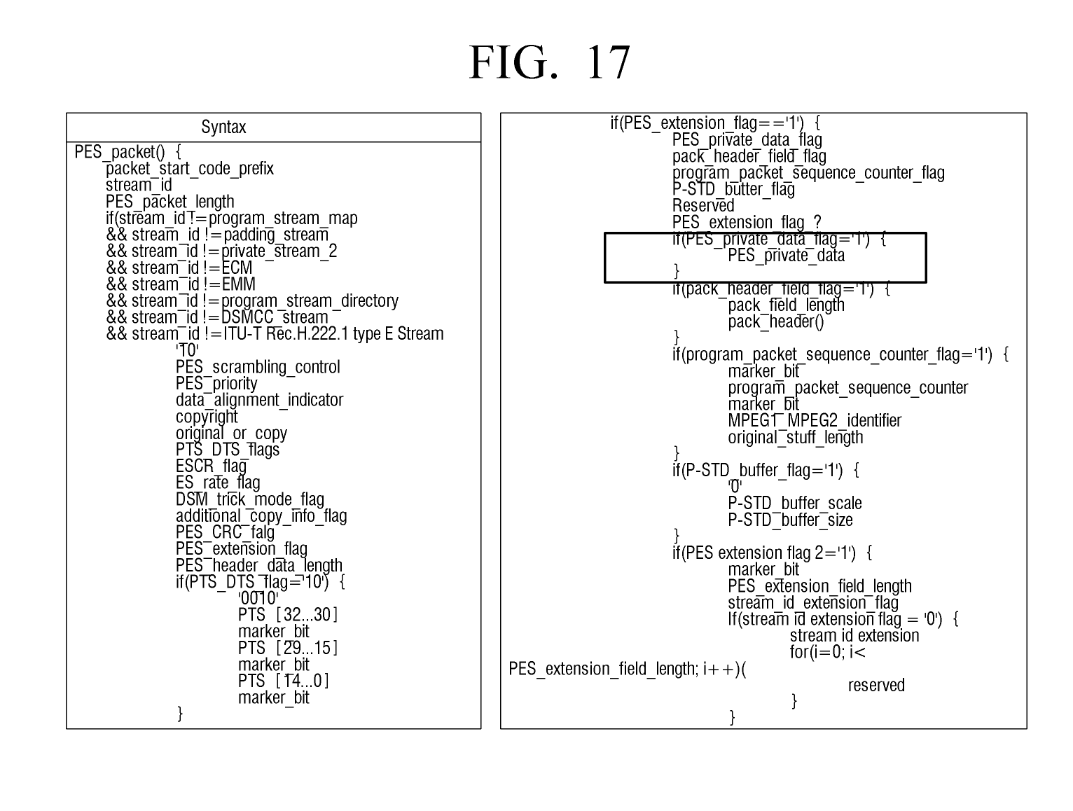

FIG. 17 illustrates a method of delivering synchronizing information by using PES header. PES packet header may record and transmit respective synchronizing information on PES_private_data because it is provided on a frame basis. Referring to FIG. 17, PES_private_data may be set as 1 and synchronizing information may be recorded on PES_private_data.

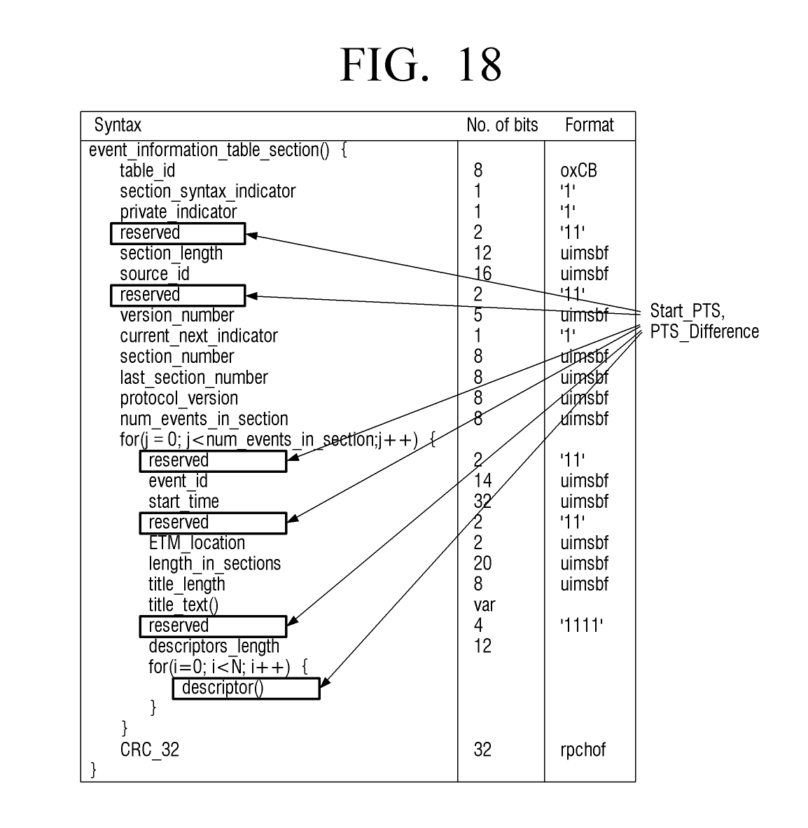

FIG. 18 illustrates a method of delivering synchronizing information such as content start information, time stamp difference value, and frame index by using EIT. Such information may be recorded and transmitted on reserved area of EIT or expanded area of new or previous descriptor.

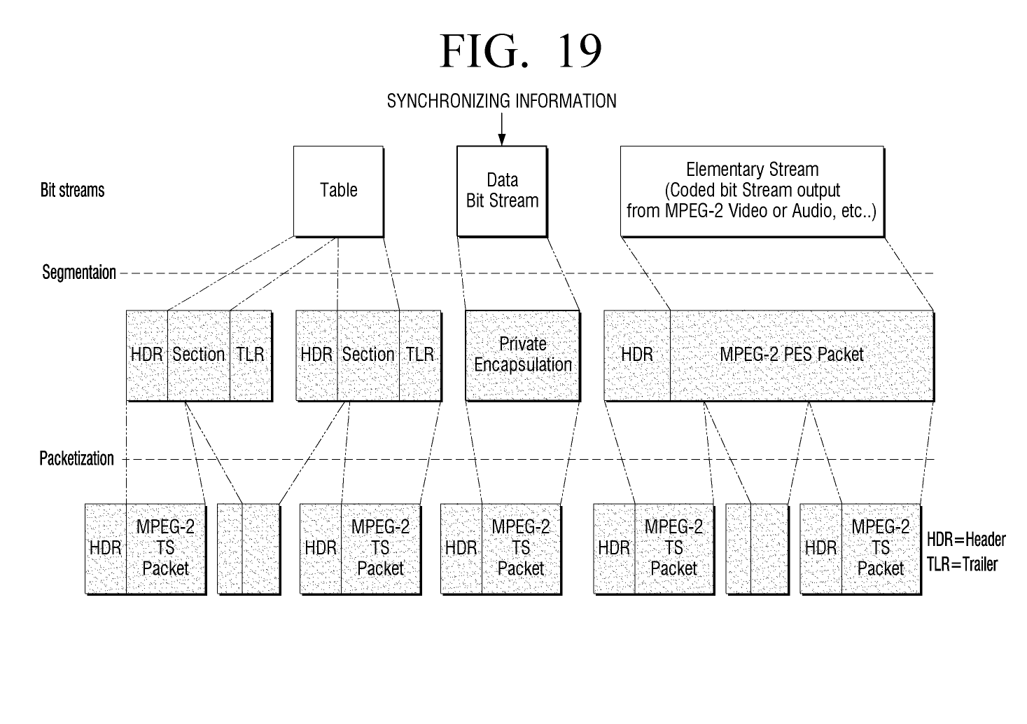

FIG. 19 illustrates a method of delivering synchronizing information by using a private stream. As illustrated in FIG. 19, a private stream, in which synchronizing information such as content start information, time stamp information and frame index information are recorded, i.e., data bit stream, may be included and transmitted separately from the PES. In this case, reserved value as well as predefined 0xBD and 0xBF may be used as a stream ID of the PES header. Besides, time code, UTC or frame count information may be transmitted by using the private stream, which will be further described below.

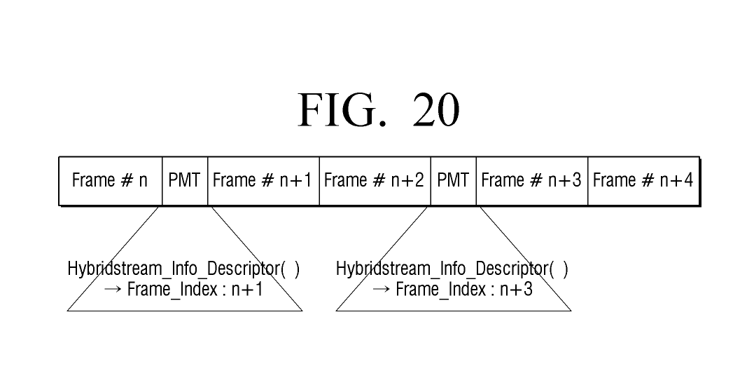

FIG. 20 illustrates an example of a transport stream structure which includes a frame index among synchronizing information. According to the MPEG standard, the transport stream transmit video, audio and other extra data. Information of each program is recorded on the PMT.

Although FIG. 20 illustrates a structure in which the frame index is inserted in the PMT, the frame index may be inserted in a video stream header, an audio stream header, and a TS header according to another exemplary embodiment. Referring to FIG. 20, the frame index of a next frame is recorded in each PMT. When more than two PMT are provided between the frames, the value of Hybridstream_Info_Descriptor( ) indicates the same frame index. If Descriptor( ) can be inserted based on I frame basis in a multiplexer of the transmission device, overlapping with data may be prevented.

The reception device 100 may detect the frame index by considering each PMT, and respectively synchronize frames of the first and second signals. When data is transmitted in an unreal-time transport stream format rather than the real-time transport stream format, the frame index may be provided in a different method from the above.

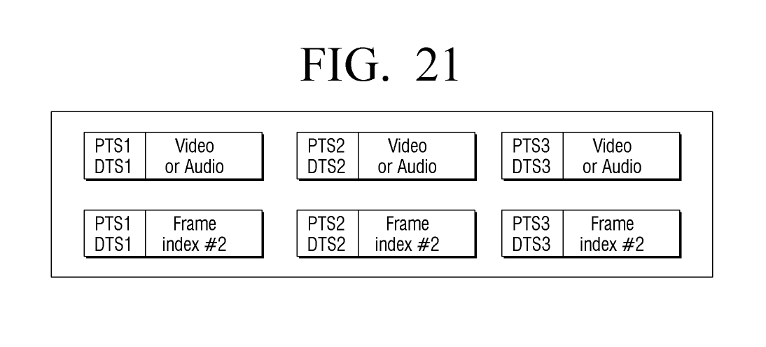

FIG. 21 illustrates an example of transmitting the frame index through a private stream. As illustrated in FIG. 21, the private stream, which is separate from multimedia stream, such as video or audio, may be provided in the first signals, and frame index value to be synchronized with the second signals may be provided through a corresponding private stream. In this case, if the second signals are also real-time transport streams having the same structure of FIG. 21, the frame index may be detected from a private stream of corresponding transport stream and synchronized.

According to another exemplary embodiment, time code, UTC information, and frame count information may be used as synchronizing information.

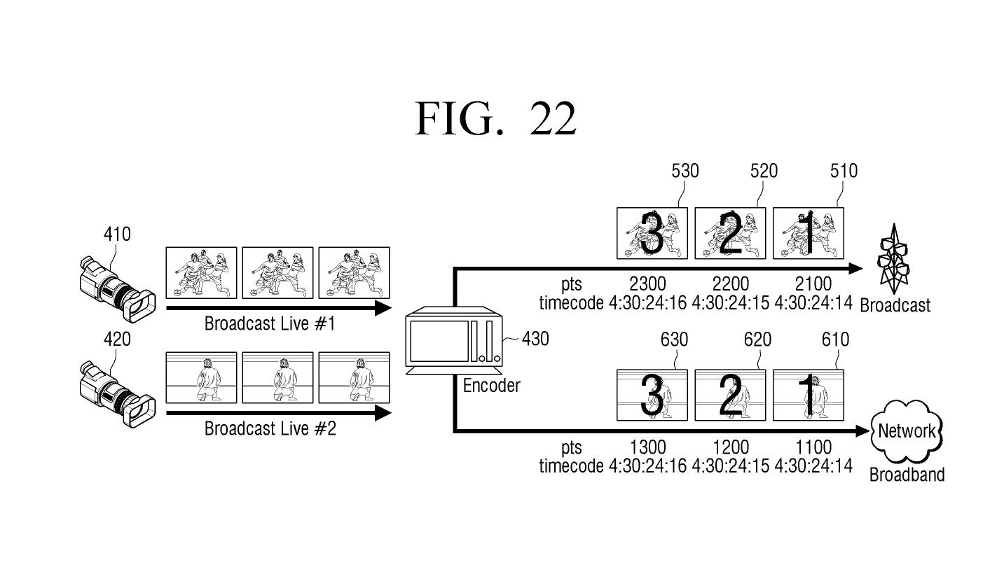

FIG. 22 illustrates a method of transmitting at a real time by using the time code of images photographed by a plurality of cameras. Referring to FIG. 22, the first and second data photographed by the plurality of cameras are respectively encoded and transmitted through the broadcasting network or the communication network. In this case, when data includes the same image, a uniform time code is allocated to corresponding data frames. In other words, time codes are uniformly generated regarding frames 51, 52, 53 of the first data and frame 61, 62, 63 of the second data even though time stamps, i.e., PTS are different from each other. Such time codes may be used as synchronizing information at the receiving side.

Time code is a series of pulse signals which are generated by a time code generator, and signal standard developed for easy editing and managing. When producing and editing content, a uniform time code is used for sync-managing left-eye and right-eye images. Therefore, a time code may keep uniform pairs regardless of stream generation or transport time point.

Specifically, Society of Motion Picture and Television Engineers (SMPTE) time code may be used. At SMPTE 12M, time code is expressed in “hour:minute:second:frame” format. SMPTE time code may be divided into longitude time code (LTC) or vertical interval time code (VITC) according to a recording method. LTC is recorded according to a moving direction of tapes. Regarding LTC, a total of 80 bits of data may be generated by including time information (25 bits), user information (32 bits), synchronizing information (16 bits), storing area (4 bits), and frame mode expressing (2 bits). VITC is recorded on two horizontal lines within vertical blanking interval of video signals.

SMPTE RP-188 defines interface standard that time code of LTC or VITC type can be transmitted as ancillary data. Thus, time code and additional information related with the time code may be newly defined and transmitted according to the interface standard.

Additional information related with the time code may be time code of other images that are provided if time codes of the left-eye and right-eye images are not the same, 2D/3D converting information to inform whether current image is dimensional or not, and start point information of dimensional images. Such additional information may be provided through the user information area or reserved area (non-assigned area). Further, regarding media excluding time code, time code dimension may be expansively defined and used in network protocol. For example, time code may be provided through RTP header extension.

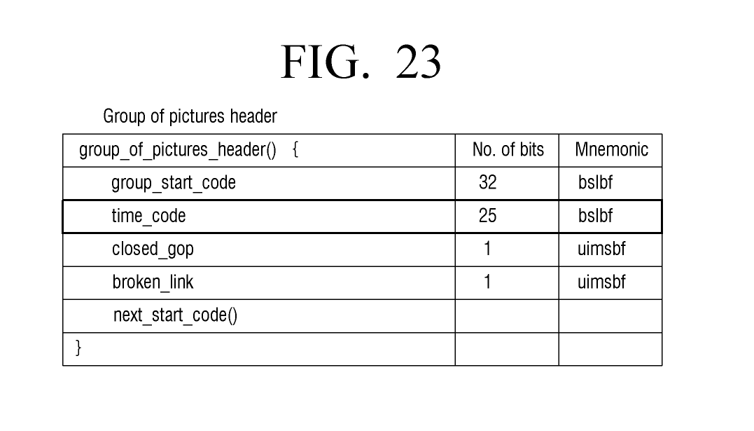

FIG. 23 illustrates an example of GoP header syntax structure within an MPEG stream that time code is recorded within the GoP header. Referring to FIG. 23, time code may be recorded as 25 bits of data. As illustrated in FIG. 23, time code may be delivered on a GoP basis to the reception device 100.

Further, the time code may be recorded on a private stream and transmitted. Thus, the private stream on which the time code is recorded, i.e., the data bit stream, may be included separately from the PES and transmitted. In this case, reserved value may be used as stream ID of the PES header other than predefined 0xBD and 0xBF. Besides, the UTC or frame count information may be similarly transmitted as time code.

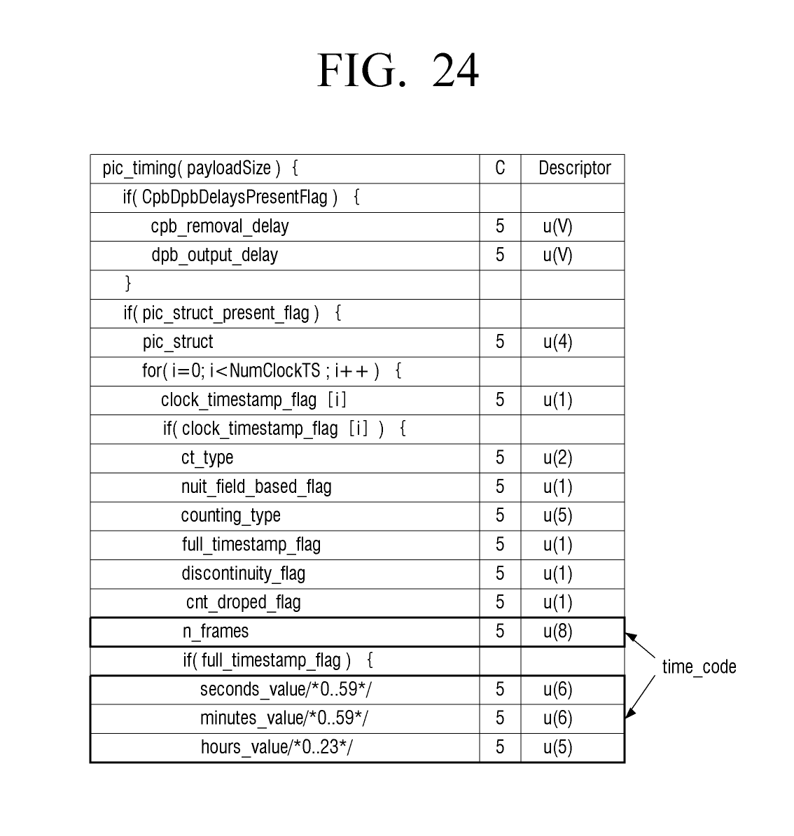

FIG. 24 illustrates a stream structure in the case in which time code is provided by using a video stream. Referring to FIG. 24, time code may be transmitted by using SEI defined in advanced video coding: ISO/IEC 14496-10 (AVC). As illustrated in FIG. 24, the time code may be delivered by using seconds_value, minutes_value, hours_value, and n_frames defined in picture timing SEI.

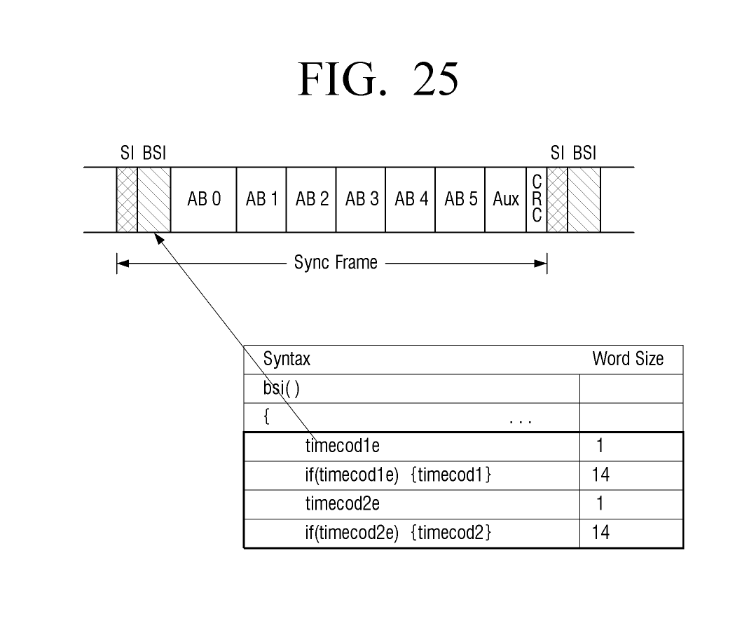

FIG. 25 illustrates a stream structure in the case in which a time code is provided by using an audio stream. As illustrated in FIG. 25, the audio stream has a structure in which the sync frame is consecutively arranged according to AC-3 (ATSC A/52: 2010).

Bit stream information (BSI) area to provide sync frame information among the sync frame structure may provide information regarding time code.

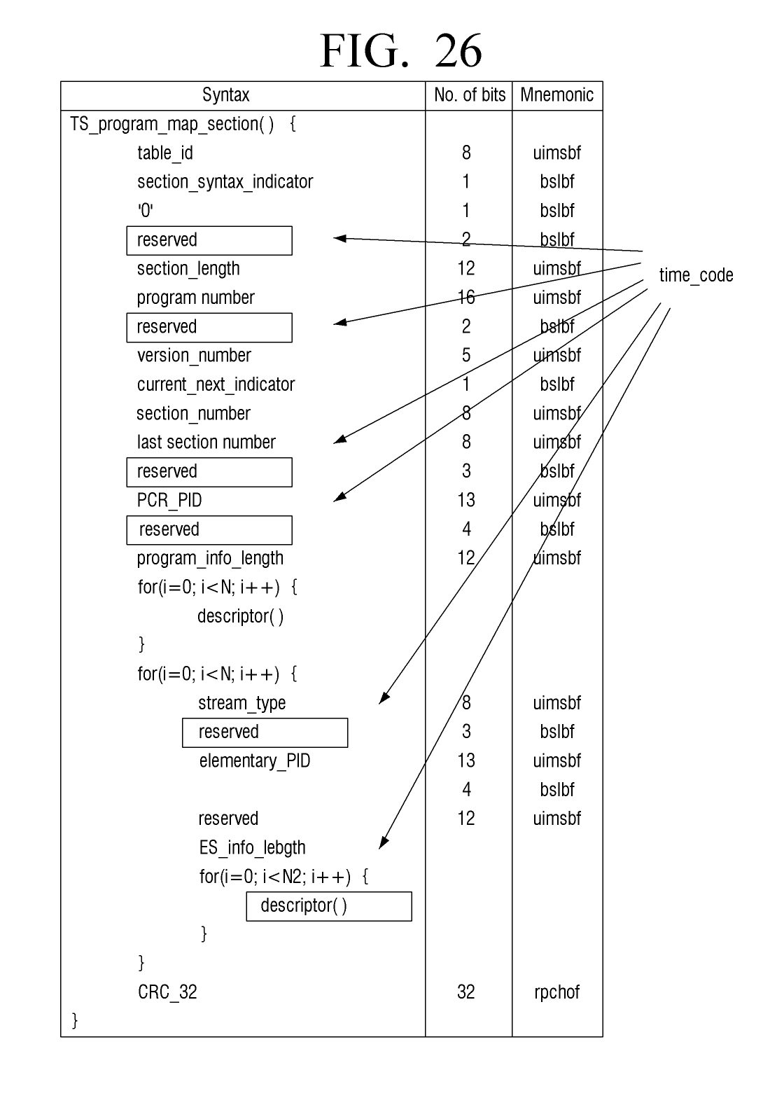

FIG. 26 illustrates the PMT syntax in the case in which the time code is provided through the PMT. Referring to FIG. 26, the time code may be provided through reserved or descriptor of PMT which is periodically transmitted. The interval of providing the PMT may be performed based on GoP to allocate the synchronized time code or frame. Although FIG. 20 illustrates that the PMT is transmitted per two frames, the PMT including the time code may be provided per one frame. As described above, various information may be used as synchronizing information, and the position of the information may be established variously.

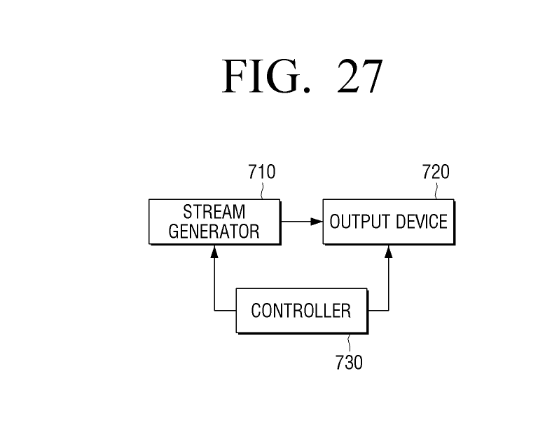

FIG. 27 is a block diagram describing an example of a transmission device which transmits real-time transport stream. The transmission device of FIG. 27 may be implemented as any one of transmission device 1 or transmission device 2 in the system of FIG. 1. However, the following will be explained based on the case that the transmission device is implemented as transmission device 1 for convenient explanation. The transmission device may include a stream generator 710, the output device 720, and the controller 730.

The stream generator 710 generates the first real-time transport stream including the first data and first synchronizing information. The first data may be one of left-eye and right-eye images. In this case, the second data which is the other image of the left-eye and right-eye images may be provided to the reception device from another transmission device. Therefore, the first and second data may be combined to express 3D images. According to the exemplary embodiments, the first data may be at least one of video data, audio data, script data and additional data which generate multimedia content. Further, the first synchronizing information is information to adjust synchronization between the first data and the second data. Types of the first synchronizing information are already described above, which will not be further explained.

The output device 720 transmits the generated stream in the stream generator 710 to the reception device 100. Detailed constitution of the output unit 720 may be implemented differently according to the types of streams. For example, when the transmission device of FIG. 27 is a broadcasting transmitting device, the output device 720 may be implemented to include a Reed Solomon (RS) encoder, an interleaver, a trellis encoder, and a modulator. Further when the transmission device of FIG. 27 is a web server which transmits stream data through a network such as the Internet, the output device 720 may be implemented as a network interface module which communicates with the reception device, i.e., web client according to HTTP protocol.

The controller 730 controls the output device 720 to delay an output timing of the first real-time transport stream so as to be adjusted for an output timing of another transmission device. Herein, another transmission device indicates a device which transmits the second real-time transport stream including the second data and second synchronizing information. The second data indicates data to generate a single multimedia content with the first data.

Information regarding output timing may be adjusted by sharing time information of broadcasting programs. For example, there are various stream generators such as a broadcasting station which transmits video and audio, a third party which transmits additional data such as scripts, and another third party which provides relevant games. One of such stream generators may transmit time plan based on time code toward other generators. Each stream generator may generate and add synchronizing information to the transport stream by using the time plan, and adjust with other transmission devices by delaying transport timing of the transport stream. Such time plan or synchronizing information is frame basis information which has correctness for synchronizing stream generating sides differently from the time schedule provided from related art Electronic Program Guides (EPG).

Further, each stream generator may download and share standard time, i.e., PCT through the related art standard server. Therefore, when transmitting performs on the same timing or when its communication speed is faster than that of the other transmission devices, transmitting speed may be delayed. Further, regarding frames of the same content, DTS and PTS may be generated and added.

The controller 730 controls the stream generator 710 and the output device 720 to perform the above delay operation and synchronizing information generating operation.

For convenient explanation, FIG. 27 explains that the transmission device which transmits a data stream including the first data, delays transmission. However, another transmission device which transmits a data stream including the second data may delay transmission. In this case, another transmission device may have the elements of FIG. 27.

Further, when the transmission device delays stream transmission as illustrated in FIG. 27, the reception device may not need process delaying after receiving the stream. In view of the whole system including the transmission device and the reception device, operation of delaying stream processing may be performed only by the transmission device or only by the reception device. Therefore, when the transmission device delays stream transmission as illustrated in FIG. 27, the reception device may not be implemented as shown in FIG. 1.

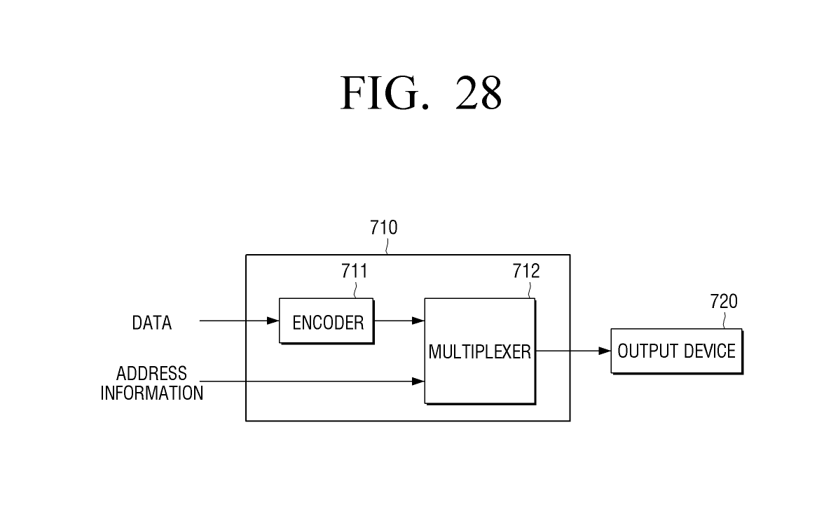

FIG. 28 is a block diagram describing the elements of a transmission device which transmits real-time transport stream according to an HTTP streaming method. Referring to FIG. 28, the transmission device includes the stream generator 710 and the output device 720, and the stream generator 710 includes an encoder 711 and a multiplexer 712.

The stream generator of FIG. 28 generates the first real-time transport stream including the first data and address information. Address information indicates information regarding metadata files that the second data constituting multimedia content with the first data can be obtained in the communication network. Specifically, it may be URL information regarding the server which provides metadata files.

The encoder 711 may receive the first data from content providers. The encoder 711 encodes the first data and provides the data to the multiplexer 712. The multiplexer 712 generates the first real-time transport stream by multiplexing the encoded first data and address information.

When transmitting synchronizing information together, the encoder 711 may be provided with signaling information from content providers. Signaling information indicates basic information requested for generating synchronizing information. The encoder 711 generates synchronizing information by using the signaling information and adds to the encoded first data.

When the synchronizing information is content start information, the encoder 711 generates a time stamp of the initial frame based on PCR and adds the time stamp as synchronizing information. Further, when difference value of time stamps are used as synchronizing information, the signaling information may be implemented as information regarding PCR of another transmission device which generates and transmits the second data. Based on the signaling information, the encoder 711 may generate difference value of time stamps between the first and second data as synchronizing information and add to the encoded first data.

If a time code is used as synchronizing information, the first data and synchronizing information may be inputted to the encoder 711 without other signaling information. The encoder 711 encodes the first data and synchronizing information without additional processing and provides the data to the multiplexer 712. Further, the address information may be inputted to the encoder 711 together and encoded with the first data.

of the elements for performing video data compression according to MPEG standards may be added to the stream generator 710. However, an illustration and description of these elements is not included herein.

The multiplexer 712 generates transmission data by muxing additional data to the generated data in the encoder 711. Additional data may be PSIP and EPG information.

The output device 720 performs channel decoding and modulating regarding the transport stream provided from the multiplexer 712, converts the stream to transport signals, and transmits the signals through channels. For modulating, a 8VSB method which is used in ground broadcasting and a 16VSB method which is a high data rate method for cable TV may be used.

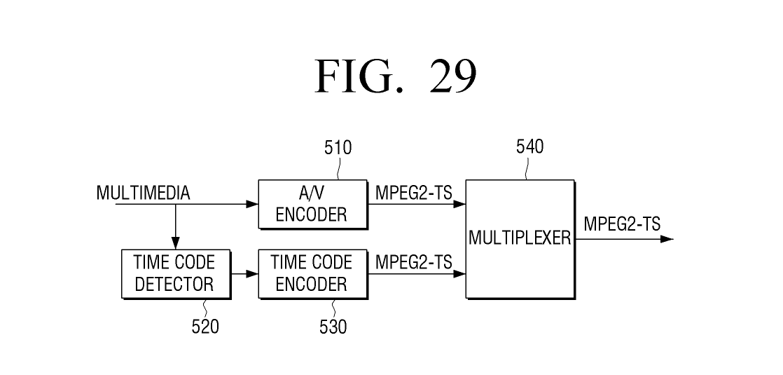

FIG. 29 illustrates the elements of a transmission device according to another exemplary embodiment. The transmission device of FIG. 29 processes time code as a separate private stream and transmits the stream. Referring to FIG. 29, the transmission device includes an audio/video (A/V) encoder 510, a time code detector 520, a time code encoder 530, and a multiplexer 540.

A/V encoder 510 encodes A/V data included in the inputted multimedia data. The encoding method may be different according to a standard applied to the transmission device.

The time code detector 520 detects a time code of images from the inputted multimedia data and provides the time code to the time code encoder 530. The detected time code may be stored as a time line data file. In this case, various additional information as well as the time code may be detected together and provided to the time code encoder 530.

The time code encoder 530 encapsulates the detected time code in proper transmission format, combines a presentation time stamp calculated by using the same program system clock as A/V encoder 510, and synchronizes the time stamp with A/V data processed in A/V encoder 510.

Time code information processed in the time code encoder 530 is provided to the multiplexer 540 with A/V data processed in A/V encoder 510. The multiplexer 540 multiplexes such data and outputs MPEG2-TS.

Although not illustrated in FIG. 29, various other elements such as a pilot inserter, a modulator, an interleaver, a randomizer, and RF upconverter may be added to the transmission device. These elements may be considered as normal elements of the transmission device, which will not be further illustrated and explained.

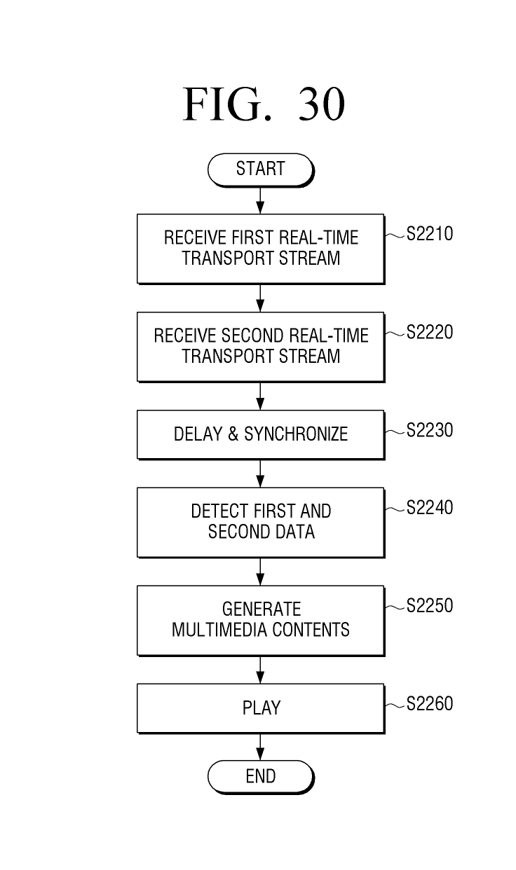

FIG. 30 is a flowchart illustrating a method of playing multimedia content according to an exemplary embodiment.

Referring to FIG. 30, when the first real-time transport stream is received through a communication network at operation S2210, and the second real-time transport stream is received through another communication network at operation S2220, at least one of the two transport streams are delayed and synchronized with each other at operation S2230.

At operation S2240, the first data and the second data are detected from each of the two streams. The detected first and second data are combined to generate multimedia content at operation S2250 and multimedia content are played at operation S2260.

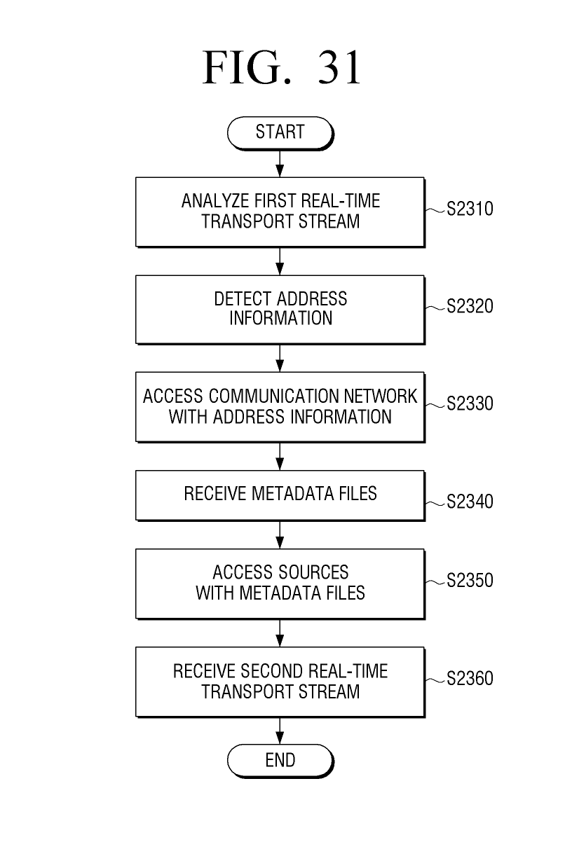

FIG. 31 is a flowchart specifically illustrating a method of receiving the second real-time transport stream. Referring to FIG. 31, when the first real-time transport stream is received, the first real-time transport stream is analyzed at operation S2310 and address information is detected at operation S2320. Thus, the communication network is accessed by using the detected address information at operation S2330.

Therefore, metadata files are received from the server corresponding to the address information at operation S2340, and sources are accessed by using the metadata files at operation S2350. At operation S2360, the second real-time transport stream is received from corresponding sources.

The first and second real-time transport stream may include synchronizing information respectively. Further, because the elements of the metadata files and the recording position of the address information within the stream are explained specifically in the discussion above, it will not be further described.

Further, the first and second data may be data comprising 3D content such as left-eye and right-eye images, or parts of data comprising one multimedia content such as video, audio and scripts, as described above.

A program to implement the methods according to the above various exemplary embodiments may be stored and used in various types of recording medium.

Specifically, codes to implement the above methods may be stored in various types of recording medium that can be read by a terminal such as random access memory (RAM), flash memory, read only memory (ROM), erasable programmable ROM (EPROM), electronically erasable and programmable ROM (EEPROM), register, hard disk, removable disk, memory card, USB memory, and CD-ROM.

Further, the foregoing exemplary embodiments are merely exemplary and are not to be construed as limiting. The present teaching can be readily applied to other types of apparatuses. Also, the description of the exemplary embodiments of the present inventive concept is intended to be illustrative, and not to limit the scope of the claims.

1-15. (canceled)

16. A reception device, comprising:
a first receiver configured to receive a first real-time transport stream through a broadcasting network;
a second receiver configured to receive a second real-time transport stream through a communication network;
a delay processor configured to synchronize the first real-time transport stream and the second real-time transport stream by delaying at least one of the first real-time transport stream and the second real-time transport stream;
a first detector configured to detect a first data from the first real-time transport stream;
a second detector configured to detect a second data from the second real-time transport stream;
a signal processor configured to generate a multimedia content by combining the first data and the second data; and
a playback device configured to play the multimedia content.

17. The reception device of claim 16, wherein the first real-time transport stream comprises address information, and the second receiver is configured to receive metadata files from a server by accessing the server within the communication network with the address information, and is configured to receive the second real-time transport stream based on the metadata files, and the metadata files comprise information regarding sources of the second real-time transport stream.

18. The reception device of claim 17, wherein if the address information is based on a H.264 standard, the address information is recorded on at least one of: a reserved area within a program map table (PMT) of the first real-time transport stream, a descriptor area within the PMT, a reserved area of the first real-time transport stream, a private data area of the first real-time transport stream, a reserved area within a Program Elementary Stream (PES) of the first real-time transport stream, a private data area within the PES of the first real-time transport stream, a user area within an Elementary Stream (ES) header, a private area within the ES header, a Supplemental Enhancement Information (SEI).

19. The reception device of claim 16, wherein the second data comprises a plurality of data units which have at least one size established according to a state of the communication network.

20. The reception device of claim 16, wherein one of the first data and the second data comprises a left-eye image and the other of the first data and the second data comprises a right-eye image, and the multimedia content is three-dimensional (3D) content.

21. The reception device of claim 20, wherein the first real-time transport stream comprises first synchronizing information, the second real-time transport stream comprises second synchronizing information, and the first synchronizing information and the second synchronizing information comprise at least one of content start information to inform a start point of the multimedia content, a difference value of time stamps between the first data and the second data, and a frame index.

22. The reception device of claim 21, further comprising:
a controller configured to control the signal processor to compensate at least one of time stamps in each frame included in the first data and time stamps in each frame included in the second data based on the first synchronizing information and the second synchronizing information, and generate the multimedia content by combining each frame of the first data and the second data.

23. The reception device of claim 20, wherein the first real-time transport stream comprises first synchronizing information, the second real-time transport stream comprises second synchronizing information, and the first synchronizing information and the second synchronizing information are time code information of image frames.

24. A transmission device, comprising:
a stream generator configured to generate a first real-time transport stream comprising a first data and first synchronizing information;
an output device configured to output the first real-time transport stream; and
a controller configured to control the output device to delay an output timing of the first real-time transport stream adjusted for an output timing of other transmission devices which output a second real-time transport stream,
wherein the second real-time transport stream comprises a second data and second synchronizing information, the first data and the second data are data to generate one multimedia content, and the first synchronizing information and the second synchronizing information are information transmitted for synchronization of the first data and the second data.

25. A transmission device, comprising:
a stream generator configured to generate a first real-time transport stream comprising a first data and address information; and
an output device configured to output the first real-time transport stream,
wherein the address information is address information regarding metadata files that a second data generating multimedia content with the first data is obtained on a communication network.

26. A method of playing multimedia content at a reception device, the method comprising:
receiving a first real-time transport stream from a broadcasting network;
receiving a second real-time transport stream from a communication network;
delaying at least one of the first real-time transport stream and the second real-time transport stream and synchronizing the first real-time transport stream and the second real-time transport stream;
detecting a first data from the first real-time transport stream and detecting a second data from the second real-time transport stream;
generating a multimedia content by combining the first data and the second data; and
playing the multimedia content.

27. The playing method of claim 26, wherein the receiving the second real-time transport stream through the communication network comprises,
detecting address information included in the first real-time transport stream;
receiving metadata files from a server by accessing the server within the communication network with the address information; and
receiving the second real-time transport stream by accessing sources of the second real-time transport stream with the metadata files.

28. The playing method of claim 27, wherein one of the first data and the second data comprises a left-eye image and the other of the first data and the second data comprises a right-eye image, and the multimedia content is three-dimensional (3D) content.

29. The playing method of claim 26, wherein the second data comprises a plurality of data units which have at least one size established adaptively according to a state of the communication network.

30. The playing method of claim 29, wherein the first real-time transport stream comprises first synchronizing information, the second real-time transport stream comprises second synchronizing information, and the first synchronizing information and the second synchronizing information comprise at least one of content start information to inform a start point of the multimedia content, a difference value of time stamps between the first data and the second data, a frame index, and a time code.
